(19) United States
(12) Patent Application Publication
(10) Pub. No.: US 2006/0182180 A1
(43) Pub. Date: Aug. 17, 2006

(54) Encoding apparatus and method, decoding apparatus and method, recording medium, image processing system, and image processing method

(76) Inventors: Shinsuke Araya, Kanagawa (JP); Tetsujiro Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/342,652

(22) Filed: Jan. 31, 2006

(30) Foreign Application Priority Data
Feb. 4, 2005 (JP) 2005-029543

(51) Int. Cl. H04N 11/04

(52) U.S. Cl. 375/240.24

(57) ABSTRACT

An encoding apparatus for encoding input image data includes a splitting section that splits the image data into blocks of a predetermined size, a detection section that detects, as a characteristic amount of each block split by the splitting section, at least the number of extreme values representing the number of pixels whose pixel values are extreme values, a determination section that determines an encoding method for the block in accordance with the characteristic amount detected by the detection section, and an encoding section that encodes the image data of the block in accordance with the encoding method for the block determined by the determination section.

### CROSS REFERENCES TO RELATED APPLICATIONS

The present invention contains subject matter related to Japanese Patent Application JP 2005-029543 filed in the Japanese Patent Office on Feb. 4, 2005, the entire contents of which are incorporated herein by reference.

### BACKGROUND OF THE INVENTION

1. Field of the Invention

The present invention relates to encoding apparatuses and methods, decoding apparatuses and methods, recording media, image processing systems, and image processing methods, and more particularly, to an encoding apparatus and method, a decoding apparatus and method, a recording medium, an image processing system, and an image processing method suitable for inhibiting copying of analog data.

2. Description of the Related Art

When a general recording medium (for example, a digital versatile disc (DVD) or a cassette magnetic tape, such as a video home system (VHS)) on which image signals, such as video content, are recorded is played back by a playback apparatus and playback results are supplied as analog data to a television receiver or the like, if the analog data supplied to the television receiver or the like is branched to be input to a predetermined recording apparatus, the video content can be copied.

However, such copying may infringe copyright. Thus, methods for inhibiting illegal copying of video content and the like have been proposed.

More specifically, a method for scrambling analog data output from a playback apparatus or inhibiting output of analog data is proposed, for example, in Japanese Unexamined Patent Application Publication No. 2001-245270.

The above-mentioned known method is capable of inhibiting illegal copying of analog data. However, a television receiver or the like to which the analog data is supplied is not capable of displaying normal images.

Thus, in order to solve the above-mentioned problem, the assignee of this application has proposed a technology in which when analog data is converted into digital data and encoded, the image quality after decoding is degraded by performing encoding processing with attention focused on analog noise, such as phase shift (see, for example, Japanese Unexamined Patent Application Publication No. 2004-289685).

According to the technology described in Japanese Unexamined Patent Application Publication No. 2001-245270, illegal copying of analog data can be inhibited. In addition, according to the technology described in Japanese Unexamined Patent Application Publication No. 2004-289685, a television receiver or the like to which the analog data is supplied is capable of displaying normal images.

However, in order to solve the above-mentioned problem, besides the technology described in Japanese Unexamined Patent Application Publication No. 2004-289685, further technologies for inhibiting illegal copying of analog data are desired.

### SUMMARY OF THE INVENTION

It is desirable that when a series of processing in which analog data is digitized and encoded and the obtained digital encoded data is decoded is repeated, results of the second and subsequent decoding processing be deteriorated although encoding and decoding processing similar to first encoding and decoding processing is performed. Accordingly, copying of analog data can be inhibited.

An encoding apparatus according to an embodiment of the present invention includes a splitting section that splits image data into blocks of a predetermined size, a detection section that detects, as a characteristic amount of each block split by the splitting section, at least the number of extreme values representing the number of pixels whose pixel values are extreme values, a determination section that determines an encoding method for the block in accordance with the characteristic amount detected by the detection section, and an encoding section that encodes the image data of the block in accordance with the encoding method for the block determined by the determination section.

Noise may be added to the image data.

The encoding apparatus may further include a noise-adding section that adds noise to the input image data.

After the image data is encoded at least once, the image data may be decoded.

The encoding apparatus may further include a decoding section that decodes an output result of the encoding section.

The detection section may detect, as the characteristic amount of the block split by the splitting section, an activity representing a variation of pixel values of pixels included in the block and a dynamic range of the pixels included in the block.

The determination section may classify the blocks into block groups in accordance with the characteristic amount detected by the detection section, and may determine an identical encoding method for blocks belonging to an identical block group.

The determination section may determine, as an encoding method, a quality functioning as a parameter for determining an image quality in discrete cosine transform. The encoding section may perform the discrete cosine transform on the image data of the block using a quantization table adjusted in accordance with the quality determined by the determination section.

The encoding section may output, as encoding results, a discrete cosine coefficient acquired by the discrete cosine transform and the quality for the block.

The determination section may determine, as an encoding method, a degree of an approximate expression representing relationship between pixel values and pixel positions of pixels included in the block in accordance with the characteristic amount detected by the detection section. The encoding section may calculate, in accordance with the pixel values and the pixel positions of the pixels included in the block, a coefficient of each degree term of the approximate expression whose degree is determined by the determination section.

The determination section may determine, as an encoding method, a degree i of a two-dimensional ith-degree polynomial representing relationship between pixel values and pixel positions of pixels included in the block in accordance with the characteristic amount detected by the detection section. The encoding section may calculate, using a least squares method based on the pixel values and the pixel positions of the pixels included in the block, a coefficient of each degree term of the two-dimensional ith-degree polynomial whose degree i is determined by the determination section.

The encoding section may output, as encoding results, the degree i and the coefficient of the degree term of the two-dimensional ith-degree polynomial for the block.

An encoding method according to an embodiment of the present invention includes the steps of splitting image data into blocks of a predetermined size, detecting, as a characteristic amount of each block split by the splitting step, at least the number of extreme values representing the number of pixels whose pixel values are extreme values, determining an encoding method for the block in accordance with the characteristic amount detected by the detecting step, and encoding the image data of the block in accordance with the encoding method for the block determined by the determining step.

A first program of a recording medium according to an embodiment of the present invention includes the steps of splitting image data into blocks of a predetermined size, detecting, as a characteristic amount of each block split by the splitting step, at least the number of extreme values representing the number of pixels whose pixel values are extreme values, determining an encoding method for the block in accordance with the characteristic amount detected by the detecting step, and encoding the image data of the block in accordance with the encoding method for the block determined by the determining step.

In the encoding apparatus, the encoding method, and the program of the recording medium, image data is split into blocks of a predetermined size, and at least the number of extreme values representing the number of pixels whose pixel values are extreme values is detected as a characteristic amount of each split block. An encoding method for the block is determined in accordance with the detected characteristic amount, and the image data of the block is encoded in accordance with the encoding method determined for the block.

A decoding apparatus according to an embodiment of the present invention includes an extraction section that extracts from encoded data information representing an encoding method for each block, and a reconstruction section that determines a decoding method in accordance with the information extracted by the extraction section and that reconstructs image data from the encoded data in accordance with the decoding method. A characteristic amount includes at least the number of extreme values representing the number of pixels whose pixel values are extreme values.

The extraction section may extract, as the information representing the encoding method for the block, a discrete cosine coefficient acquired by discrete cosine transform and a quality from the encoded data. The reconstruction section may reconstruct the image data by performing inverse discrete cosine transform on the discrete cosine coefficient using a quantization table adjusted in accordance with the quality.

The extraction section may extract, as the information representing the encoding method for the block, a degree and a coefficient of each degree term of an approximate expression representing relationship between pixel values and pixel positions of pixels included in the block from the encoded data. The reconstruction section may reconstruct the image data by generating the approximate expression in accordance with the degree and the coefficient and by calculating the pixel values by substituting the pixel positions into the generated approximate expression.

A decoding method according to an embodiment of the present invention includes the steps of extracting from encoded data information representing an encoding method for each block, and reconstructing image data from the encoded data in accordance with a decoding method determined in accordance with the information extracted by the extracting step.

A second program of a recording medium according to an embodiment of the present invention includes the steps of extracting from encoded data information representing an encoding method for each block, and reconstructing image data from the encoded data in accordance with a decoding method determined in accordance with the information extracted by the extracting step. A characteristic amount includes at least the number of extreme values representing the number of pixels whose pixel values are extreme values.

In the decoding apparatus, the decoding method, and the program of the recording medium, information representing an encoding method for each block is extracted from encoded data, a decoding method is determined in accordance with the extracted information, and image data is reconstructed from the encoded data in accordance with the determined decoding method.

In a first image processing system according to an embodiment of the present invention, an encoding section includes a splitting unit that splits image data into blocks of a predetermined size, a detection unit that detects, as a characteristic amount of each block split by the splitting unit, at least the number of extreme values representing the number of pixels whose pixel values are extreme values, a determination unit that determines an encoding method for the block in accordance with the characteristic amount detected by the detection unit, and an encoding unit that encodes the image data of the block in accordance with the encoding method for the block determined by the determination unit.

In the first image processing system according to the embodiment of the present invention, an encoding section splits image data into blocks of a predetermined size, and detects, as a characteristic amount of each split block, at least the number of extreme values representing the number of pixels whose pixel values are extreme values. Then, the encoding section determines an encoding method for the block in accordance with the detected characteristic amount, and encodes the image data of the block in accordance with the determined encoding method for the block.

In a second image processing system according to an embodiment of the present invention, a decoding section includes an extraction unit that extracts, from encoded data encoded by an encoding method determined in accordance with a characteristic amount of image data of each block acquired by splitting the image data into blocks of a predetermined size, information representing the encoding method for the block, and a reconstruction unit that determines a decoding method in accordance with the information extracted by the extraction unit and that reconstructs the image data from the encoded data in accordance with the decoding method. The characteristic amount includes at least the number of extreme values representing the number of pixels whose pixel values are extreme values.

In the second image processing system according to the embodiment of the present invention, a decoding section extracts from encoded data information representing an encoding method for each block, determines a decoding method in accordance with the extracted information, and reconstructs the image data from the encoded data in accordance with the determined decoding method.

### BRIEF DESCRIPTION OF THE DRAWINGS

FIG. 1 is a block diagram showing a configuration example of an image display system according to an embodiment of the present invention;

FIGS. 2A and 2B are illustrations for explaining white noise;

FIGS. 3A to 3D schematically illustrate the operation of the image display system;

FIG. 4 is a block diagram showing a first configuration example of an encoding section shown in FIG. 1;

FIG. 5 is a flowchart showing the operation of the encoding section of the first configuration example shown in FIG. 4;

FIG. 6 is a block diagram showing a first configuration example of a decoding section corresponding to the first configuration example of the encoding section;

FIG. 7 is a flowchart showing the operation of the decoding section of the first configuration example shown in FIG. 6;

FIG. 8 is a block diagram showing a second configuration example of the encoding section shown in FIG. 1;

FIG. 9 is a flowchart showing the operation of the encoding section of the second configuration example shown in FIG. 8;

FIGS. 10A to 10D are illustrations for explaining methods for calculating the number of extreme values;

FIG. 11 is an illustration for explaining a method for calculating an activity;

FIGS. 12A to 12G are illustrations for explaining the operation of the encoding section of the second configuration example shown in FIG. 8;

FIG. 13 is a block diagram showing a second configuration example of the decoding section corresponding to the second configuration example of the encoding section;

FIG. 14 is a flowchart showing the operation of the decoding section of the second configuration example shown in FIG. 13;

FIGS. 15A to 15G are illustrations for explaining advantages of the encoding section of the second configuration example;

FIG. 16 is a block diagram showing a third configuration example of the encoding section shown in FIG. 1;

FIG. 17 shows an example of a one-dimensional ith-degree polynomial;

FIG. 18 shows an example of a two-dimensional ith-degree polynomial;

FIG. 19 illustrates a least squares method;

FIG. 20 illustrates a method for calculating a coefficient of the two-dimensional ith-degree polynomial;

FIG. 21 is a flowchart showing the operation of the encoding section of the third configuration example shown in FIG. 16;

FIGS. 22A to 22E are illustrations for explaining the operation of the encoding section of the third configuration example;

FIG. 23 is a block diagram showing a third configuration example of the decoding section corresponding to the third configuration example of the encoding section;

FIG. 24 is a flowchart showing the operation of the decoding section of the third configuration example shown in FIG. 23;

FIGS. 25A to 25G are illustrations for explaining advantages of the encoding section of the third configuration example; and

FIG. 26 is a block diagram showing a configuration example of a personal computer according to an embodiment of the present invention.

### DESCRIPTION OF THE PREFERRED EMBODIMENTS

Embodiments of the present invention will be described below. The description given below is intended to assure that a feature supporting an embodiment of the present invention is described in the embodiments of the present invention. Thus, even if a feature described in the following embodiments is not described herein as relating to a certain feature supporting the embodiment of the present invention, that does not necessarily mean that the feature does not relate to that feature supporting the embodiment of the present invention. Conversely, even if a feature is described herein as relating to a certain feature supporting an embodiment of the present invention, that does not necessarily mean that the feature does not relate to features supporting other embodiments of the present invention.

In addition, this description should not be construed as restricting that all the features of the invention disclosed in the embodiments are described in the claims. That is, the description does not deny the existence of aspects of the present invention that relate to features described in the embodiments but that are not claimed in the invention of this application, i.e., the existence of aspects of the present invention that in future may be claimed by a divisional application, or that may be additionally claimed through amendments.

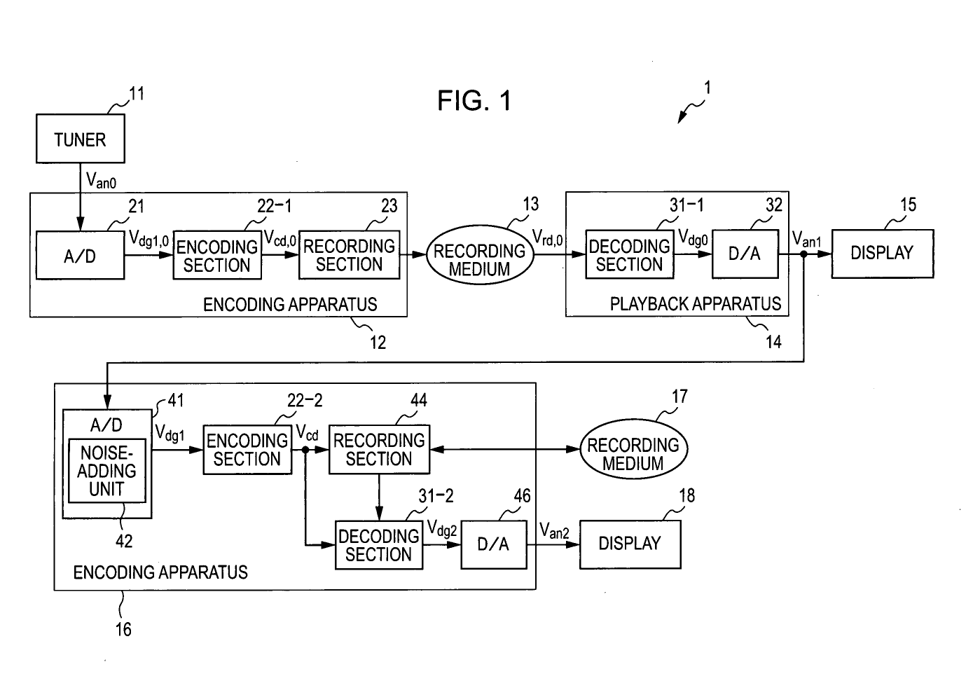

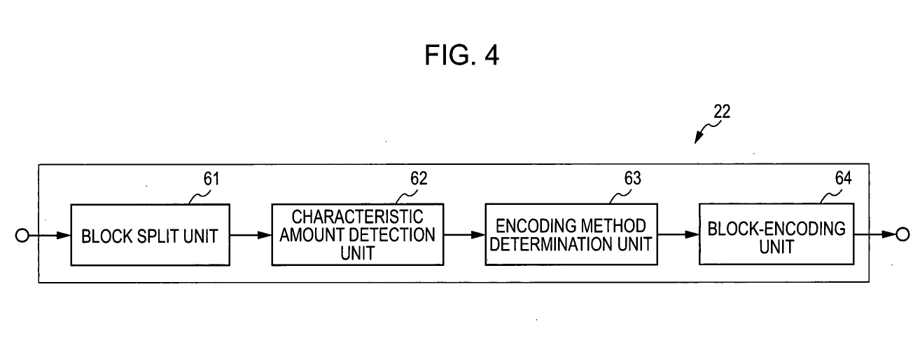

An encoding apparatus (for example, an encoding apparatus 16 in FIG. 1) according to an embodiment of the present invention includes a splitting section (for example, a block split unit 61 in FIG. 4) that splits image data into blocks of a predetermined size, a detection section (for example, a characteristic amount detection unit 62 in FIG. 4) that detects, as a characteristic amount of each block split by the splitting section, at least the number of extreme values representing the number of pixels whose pixel values are extreme values, a determination section (for example, an encoding method determination unit 63 in FIG. 4) that determines an encoding method for the block in accordance with the characteristic amount detected by the detection section, and an encoding section (for example, a block-encoding unit 64 in FIG. 4) that encodes the image data of the block in accordance with the encoding method for the block determined by the determination section.

The encoding apparatus further includes a noise-adding section (for example, a noise-adding unit 42 in FIG. 1) that adds noise to the input image data.

The encoding apparatus further includes a decoding section (for example, a decoding section 31-2 in FIG. 1) that decodes an output result of the encoding section.

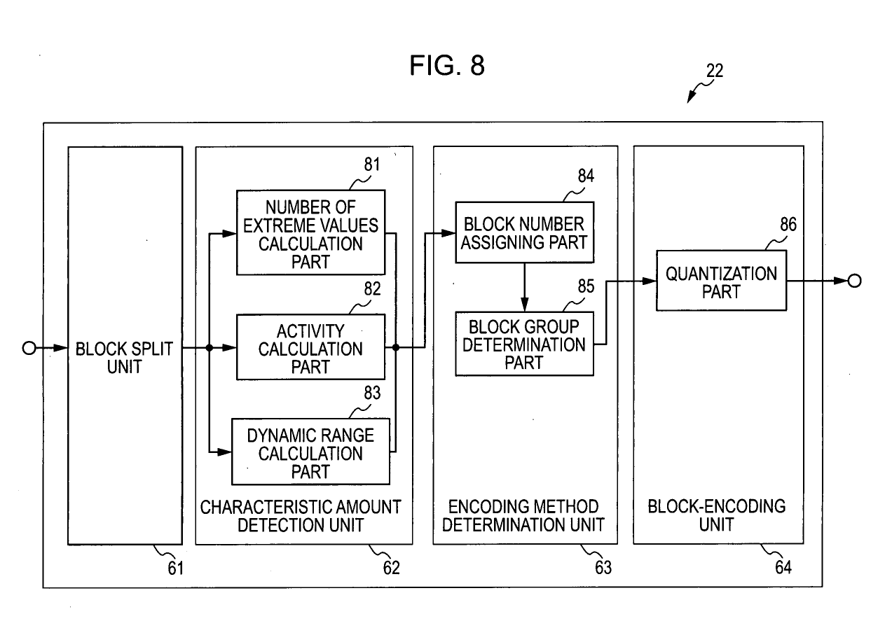

The detection section (for example, the characteristic amount detection unit 62 in FIG. 8) detects, as the characteristic amount of the block split by the splitting section, an activity representing a variation of pixel values of pixels included in the block and a dynamic range of the pixels included in the block.

The determination section (for example, the encoding method determination unit 63 in FIG. 8) classifies the blocks into block groups in accordance with the characteristic amount detected by the detection section, and determines an identical encoding method for blocks belonging to an identical block group.

The determination section (for example, the encoding method determination unit 63 in FIG. 8) determines, as an encoding method, a quality functioning as a parameter for determining an image quality in discrete cosine transform. The encoding section (for example, the quantization part 86 in FIG. 8) performs the discrete cosine transform on the image data of the block using a quantization table adjusted in accordance with the quality determined by the determination section.

The encoding section (for example, the quantization part 86 in FIG. 8) outputs, as encoding results, a discrete cosine coefficient acquired by the discrete cosine transform and the quality for the block.

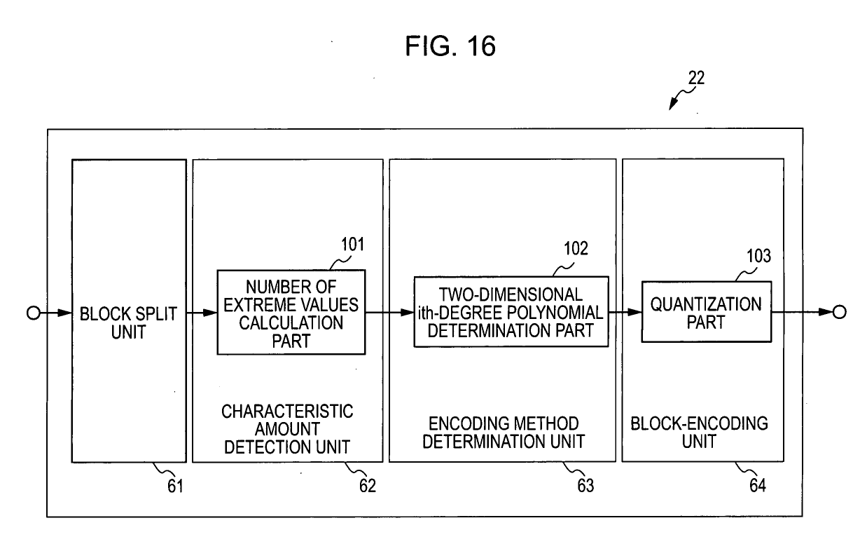

The determination section (for example, the encoding method determination unit 63 in FIG. 16) determines, as an encoding method, a degree of an approximate expression representing relationship between pixel values and pixel positions of pixels included in the block in accordance with the characteristic amount detected by the detection section. The encoding section (for example, the quantization part 103 in FIG. 16) calculates, in accordance with the pixel values and the pixel positions of the pixels included in the block, a coefficient of each degree term of the approximate expression whose degree is determined by the determination section.

The determination section (for example, the encoding method determination unit 63 in FIG. 16) determines, as an encoding method, a degree i of a two-dimensional ith-degree polynomial representing relationship between pixel values and pixel positions of pixels included in the block in accordance with the characteristic amount detected by the detection section. The encoding section (for example, the quantization part 103 in FIG. 16) calculates, using a least squares method based on the pixel values and the pixel positions of the pixels included in the block, a coefficient of each degree term of the two-dimensional ith-degree polynomial whose degree i is determined by the determination section.

The encoding section (for example, the quantization part 103 in FIG. 16) outputs, as encoding results, the degree i and the coefficient of the degree term of the two-dimensional ith-degree polynomial for the block.

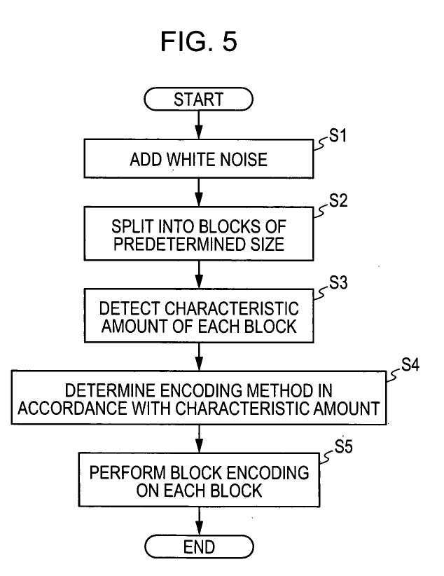

An encoding method and a program of a recording medium according to an embodiment of the present invention include the steps of splitting (for example, step S2 in FIG. 5) image data into blocks of a predetermined size, detecting (for example, step S3 in FIG. 5), as a characteristic amount of each block split by the splitting step, at least the number of extreme values representing the number of pixels whose pixel values are extreme values, determining (for example, step S4 in FIG. 5) an encoding method for the block in accordance with the characteristic amount detected by the detecting step, and encoding (for example, step S5 in FIG. 5) the image data of the block in accordance with the encoding method for the block determined by the determining step.

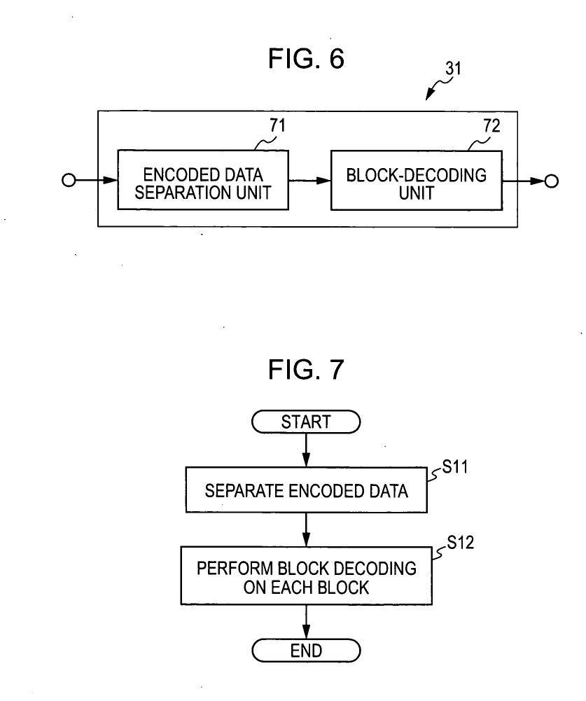

A decoding apparatus (for example, a playback apparatus 14 in FIG. 1) according to an embodiment of the present invention includes an extraction section (for example, an encoded data separation unit 71 in FIG. 6) that extracts from encoded data information representing an encoding method for each block, and a reconstruction section (for example, a block-decoding unit 72 in FIG. 6) that determines a decoding method in accordance with the information extracted by the extraction section and that reconstructs image data from the encoded data in accordance with the decoding method. A characteristic amount includes at least the number of extreme values representing the number of pixels whose pixel values are extreme values.

The extraction section (for example, the encoded data separation unit 71 in FIG. 13) extracts, as the information representing the encoding method for the block, a discrete cosine coefficient acquired by discrete cosine transform and a quality from the encoded data. The reconstruction section (for example, the dequantization part 92 in FIG. 13) reconstructs the image data by performing inverse discrete cosine transform on the discrete cosine coefficient using a quantization table adjusted in accordance with the quality.

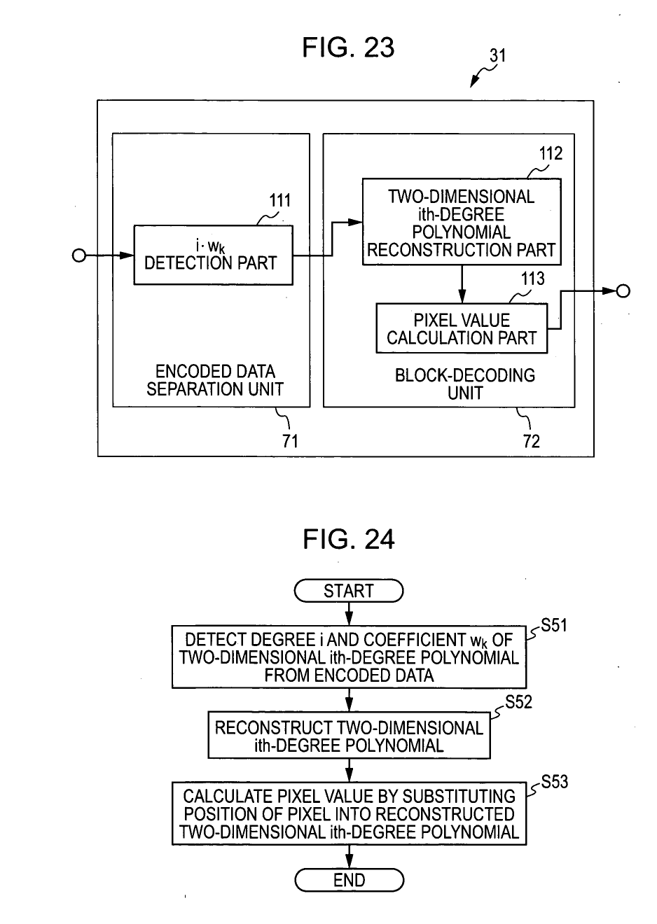

The extraction section (for example, the encoded data separation unit 71 in FIG. 23) extracts, as the information representing the encoding method for the block, a degree and a coefficient of each degree term of an approximate expression representing relationship between pixel values and pixel positions of pixels included in the block from the encoded data. The reconstruction section (for example, the block-decoding unit 72 in FIG. 23) reconstructs the image data by generating the approximate expression in accordance with the degree and the coefficient and by calculating the pixel values by substituting the pixel positions into the generated approximate expression.

A decoding method and a program of a recording medium according to an embodiment of the present invention include the steps of extracting (for example, step S11 in FIG. 7) from encoded data information representing an encoding method for each block, and reconstructing (step S12 in FIG. 7) image data from the encoded data in accordance with a decoding method determined in accordance with the information extracted by the extracting step.

In an image processing system (for example, an image display system 1 in FIG. 1) according to an embodiment of the present invention, an encoding section (for example, an encoding section 22-2 in FIG. 1) includes a splitting unit (for example, the block split unit 61 in FIG. 4) that splits image data into blocks of a predetermined size, a detection unit (for example, the characteristic amount detection unit 62 in FIG. 4) that detects, as a characteristic amount of each block split by the splitting unit, at least the number of extreme values representing the number of pixels whose pixel values are extreme values, a determination unit (for example, the encoding method determination unit 63 in FIG. 4) that determines an encoding method for the block in accordance with the characteristic amount detected by the detection unit, and an encoding unit (for example, the block-encoding unit 64 in FIG. 4) that encodes the image data of the block in accordance with the encoding method for the block determined by the determination unit.

In an image processing system (for example, the image display system 1 in FIG. 1) according to an embodiment of the present invention, a decoding section (for example, a decoding section 31-1 of the playback apparatus 14 in FIG. 1) includes an extraction unit (for example, the encoded data separation unit 71 in FIG. 6) that extracts, from encoded data encoded by an encoding method determined in accordance with a characteristic amount of image data of each block acquired by splitting the image data into blocks of a predetermined size, information representing the encoding method for the block, and a reconstruction unit (for example, the block-decoding unit 72 in FIG. 6) that determines a decoding method in accordance with the information extracted by the extraction unit and that reconstructs the image data from the encoded data in accordance with the decoding method. The characteristic amount includes at least the number of extreme values representing the number of pixels whose pixel values are extreme values.

Embodiments of the present invention will now be described with reference to the drawings.

FIG. 1 shows a configuration example of an image display system 1 according to an embodiment of the present invention. The image display system 1 includes an encoding apparatus 12, a playback apparatus 14, a display 15, an encoding apparatus 16, and a display 18. The encoding apparatus 12 encodes an analog image signal Vₐₙ₀ input from a tuner 11 or the like, and records the encoded signal on a recording medium 13. The playback apparatus 14 reads encoded digital data V_{rd,0} recorded on the recording medium 13, and plays back the read data. The display 15 displays an analog image signal Vₐₙ₁ supplied from the playback apparatus 14. The encoding apparatus 16 encodes the analog image signal Vₐₙ₁ supplied from the playback apparatus 14, and records the encoded signal on a recording medium 17. The display 18 displays an analog image signal Vₐₙ₂ supplied from the encoding apparatus 16.

The tuner 11 receives, for example, television broadcasts or the like, and outputs the obtained analog image signal Vₐₙ₀ to the encoding apparatus 12.

The encoding apparatus 12 includes an analog-to-digital (A/D) converter section 21, an encoding section 22-1, and a recording section 23. The A/D converter section 21 digitizes the analog image signal Vₐₙ₀ input from the tuner 11, and outputs an obtained digital image signal V_{dg1,0} to the encoding section 22-1. The encoding section 22-1 encodes the digital image signal V_{dg1,0}, and outputs obtained encoded digital image data V_{cd,0} to the recording section 23. The recording section 23 records the encoded digital image data V_{cd,0} on the recording medium 13.

The recording media 13 and 17 are, for example, magnetic disks, such as flexible disks, optical discs, such as compact disc read-only memories (CD-ROMs) or DVDs, optical magnetic discs, such as Mini Discs (MDs), or semiconductor memories.

The playback apparatus 14 includes a decoding section 31-1 and a digital-to analog (D/A) converter section 32. The decoding section 31-1 decodes the encoded digital data V_{rd,0} read from the recording medium 13, and outputs an obtained digital image signal V_{dg0} to the D/A converter section 32. The D/A converter section 32 converts the digital image signal V_{dg0} into an analog signal, and outputs the obtained analog image signal Vₐₙ₁ to the display 15 and the encoding apparatus 16.

In the D/A converter section 32, due to a characteristic of a general analog-to-digital converter circuit, when a digital image signal V_{dg0} is converted into an analog signal, analog noise (that is, distortion generated by adding high-frequency components called “white noise”, distortion generated by phase shift, and the like) is added to an obtained analog image signal Vₐₙ₁.

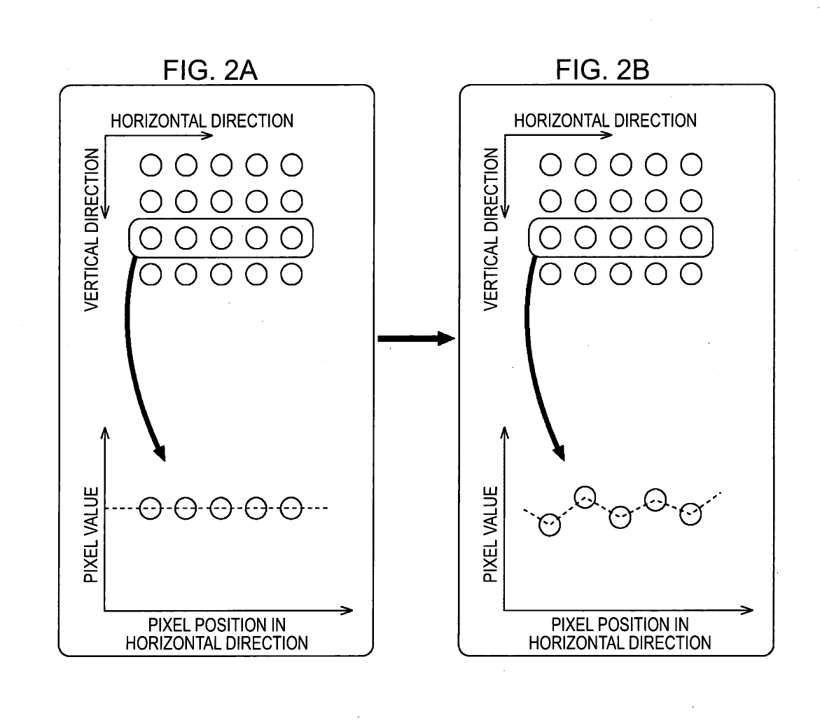

Distortion generated by adding high-frequency components will be described with reference to FIGS. 2A and 2B. As shown in FIG. 2A, parallel five pixels of a digital image signal V_{dg0} before digital-to-analog conversion by the D/A converter section 32 have the same pixel value. When an analog image signal Vₐₙ₁ to which distortion of high-frequency components is added by digital-to-analog conversion is digitized by an analog-to-digital (A/D) converter section 41 in the subsequent stage, the pixel values change, as shown in FIG. 2B. The pixel values do not change regularly, and this change is not uniformly defined. In addition, distortion of high-frequency components is added in the vertical direction as well as the horizontal direction. Hereinafter, the distortion added after digital-to-analog conversion and analog-to-digital conversion is also referred to as white noise.

Referring back to FIG. 1, the displays 15 and 17 are, for example, cathode-ray tubes (CRTs) or liquid crystal displays (LCDs). The displays 15 and 17 display images corresponding to input analog image signals.

The encoding apparatus 16 includes the A/D converter section 41, an encoding section 22-2, and a recording section 44. The A/D converter section 41 digitizes an analog image signal Vₐₙ₁ input from the playback apparatus 14, and outputs an obtained digital image signal V_{dg1} to the encoding section 22-2. The encoding section 22-2 encodes the digital image signal V_{dg1}, and outputs obtained encoded digital image data V_{cd} to the recording section 44 and a decoding section 31-2. The recording section 44 records the encoded digital image data V_{cd} on the recording medium 17, reads encoded digital image data V_{rd} recorded on the recording medium 17, and supplies the read encoded digital image data V_{rd} to the decoding section 31-2.

In addition, the encoding apparatus 16 also includes the decoding section 31-2 and a digital-to-analog (D/A) converter section 46. The decoding section 31-2 decodes the encoded digital image data V_{cd} supplied from the encoding section 22-2 or the encoded digital image data V_{rd} supplied from the recording section 44, and outputs an obtained digital image signal V_{dg2} to the D/A converter section 46. The D/A converter section 46 converts the digital image signal V_{dg2} into an analog signal, and outputs the obtained analog image signal Vₐₙ₂ to the display 18.

Since analog noise (that is, white noise) is generated in the analog image signal Vₐₙ₁ before digitization, the digital image signal V_{dg1} output from the A/D converter section 41 is in a state in which pixel values are slightly changed compared with those of the digital image signal V_{dg0} output from the decoding section 31-1, that is, in a state in which noise is superimposed.

In addition, the A/D converter section 41 may include a noise-adding unit 42. In this case, digitization may be performed after intentionally adding analog noise (that is, noise corresponding to white noise) to the analog image signal Vₐₙ₁ before digitization.

The encoding section 22-1 in the encoding apparatus 12 and the encoding section 22-2 in the encoding apparatus 16 have the same configuration, as described below. Thus, when the encoding section 22-1 and the encoding section 22-2 need not be distinguished from each other, each of the encoding section 22-1 and the encoding section 22-2 is simply referred to as an encoding section 22.

In addition, the decoding section 31-1 in the playback apparatus 14 and the decoding section 31-2 in the encoding apparatus 16 have the same configuration, as described below. Thus, when the decoding section 31-1 and the decoding section 31-2 need not be distinguished from each other, each of the decoding section 31-1 and the decoding section 31-2 is simply referred to as a decoding section 31.

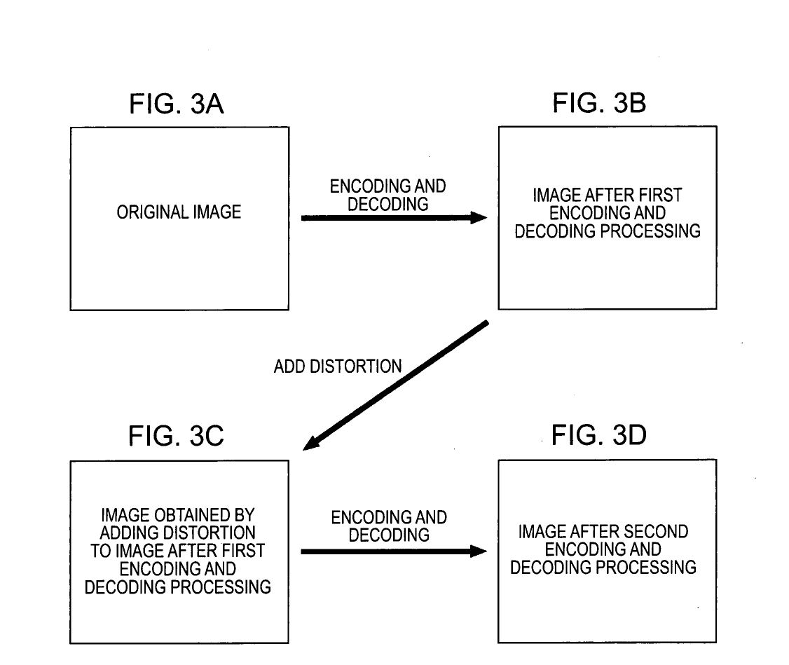

The operation of the image display system 1 is described next with reference to FIGS. 3A to 3D. The image display system 1 encodes and decodes an original image, encodes and decodes again the obtained “image after first encoding and decoding processing”, and outputs the obtained “image after second encoding and decoding processing”. The “image after first encoding and decoding processing” and the “image after second encoding and decoding processing” are defined as described below.

In other words, an original image shown in FIG. 3A corresponds to an analog image signal Vₐₙ₀ output from the tuner 11. An “image after first encoding and decoding processing” shown in FIG. 3B, which is obtained by encoding and decoding the original image, corresponds to a digital image signal V_{dg0} output from the decoding section 31-1 of the playback apparatus 14. An “image obtained by adding distortion to the image after first encoding and decoding processing” shown in FIG. 3C corresponds to an analog image signal Vₐₙ₁ output from the D/A converter section 32 of the playback apparatus 14. An “image after second encoding and decoding processing” shown in FIG. 3D corresponds to a digital image signal V_{dg2} output from the decoding section 31-2 of the encoding apparatus 16, a digital image signal obtained by decoding the recording medium 17 by the decoding section 31-1 of the playback apparatus 14, or the like.

The encoding section 22 is described next. First to third configuration examples of the encoding section 22 will be described. First to third configuration examples of the decoding section 31 will also be described correspondingly to the first to third configuration examples of the encoding section 22.

FIG. 4 shows the first configuration example of the encoding section 22. In the first configuration example of the encoding section 22, the encoding section 22 includes a block split unit 61, a characteristic amount detection unit 62, an encoding method determination unit 63, and a block-encoding unit 64. The block split unit 61 splits an input image into blocks of a predetermined size (for example, 8×8 pixels). The characteristic amount detection unit 62 detects a characteristic amount of each block (for example, the number of extreme values, an activity, a dynamic range, and the like of pixel values of pixels included in each block, which will be described below). The encoding method determination unit 63 determines, in accordance with a characteristic amount detected for each block, a Quality, which is a parameter for determining an image quality in an encoding method for each block (for example, discrete cosine transform (DCT)) or a degree i and a coefficient wₖ of a two-dimensional ith-degree polynomial, which are parameters for determining an image quality in transform using the two-dimensional ith-degree polynomial (the degree i and the coefficient wₖ will be describe below). The block-encoding unit 64 performs block encoding on each of the split blocks in accordance with the determined encoding method.

The operation of the encoding section 22 of the first configuration example will be described with reference to the flowchart shown in FIG. 5 by way of example of the encoding section 22-2 of the encoding apparatus 16.

In step S1, the noise-adding unit 42 of the A/D converter section 41 adds noise to an analog image signal Vₐₙ₁ before digitization. However, the processing in step S1 can be omitted.

In step S2, the block split unit 61 splits a digital image signal V_{dg1}, which includes noise added thereto, input from the A/D converter section 41 into blocks of a predetermined size, and outputs the blocks to the characteristic amount detection unit 62. The size of each block can be set in a desired manner. In step S3, the characteristic amount detection unit 62 detects a characteristic amount of each of the split blocks.

In step S4, the encoding method determination unit 63 determines an encoding method for each of the blocks in accordance with the characteristic amount detected for each block. In step S5, the block-encoding unit 64 performs block encoding on each of the split blocks in accordance with the determined encoding method. The block-encoding unit 64 outputs encoded digital image data V_{cd} obtained by block encoding to the subsequent stage. Then, the encoded digital image data V_{cd} is recorded on the recording medium 17 by the recording section 44 or decoded by the decoding section 31-2. As described above, the encoding section 22 of the first configuration example operates.

The first configuration example of the decoding section 31 that performs decoding processing corresponding to encoding processing performed by the encoding section 22 of the first configuration example is described next. FIG. 6 shows the first configuration example of the decoding section 31.

The decoding section 31 of the first configuration example includes an encoded data separation unit 71 and a block-decoding unit 72. The encoded data separation unit 71 separates various data for each block included in encoded digital image data V_{cd} input from the previous stage (for example, a Quality, which is a parameter for determining an image quality in DCT, and a DCT coefficient, which is a DCT result, or a degree i and a coefficient wₖ of a two-dimensional ith-degree polynomial, which are parameters for determining an image quality in transform using the two-dimensional ith-degree polynomial). The block-decoding unit 72 performs block decoding for each block (for example, calculation of a pixel value using inverse DCT or a two-dimensional ith-degree polynomial) in accordance with the separated encoded digital image data V_{cd}.

The operation of the decoding section 31 of the first configuration example will be described with reference to the flowchart shown in FIG. 7 by way of example of the decoding section 31-2 of the encoding apparatus 16. Encoded digital image data V_{cd} output from the encoding section 22-2 (or encoded digital image data V_{rd} read from the recording medium 17 by the recording section 44) is supplied to the decoding section 31-2.

In step S11, the encoded data separation unit 71 separates various data for each block included in encoded digital image data V_{cd} input from the previous stage, and outputs the separated data to the block-decoding unit 72. In step S12, the block-decoding unit 72 performs block decoding for each block in accordance with the separated encoded digital image data V_{cd}, and outputs a digital image signal V_{dg2}, which is a decoding result, to the subsequent stage.

The digital image signal V_{dg2} is the above-described “image after second encoding and decoding processing” and has lower image quality. Thus, copying of an analog image signal Vₐₙ₁ using the encoding apparatus 16 is inhibited.

FIG. 8 shows the second configuration example of the encoding section 22. In the second configuration example of the encoding section 22, compared with the first configuration example shown in FIG. 4, the characteristic amount detection unit 62, the encoding method determination unit 63, and the block-encoding unit 64 are described in more details.

The block split unit 61 splits an input image into blocks of a predetermined size (for example, 8×8 pixels).

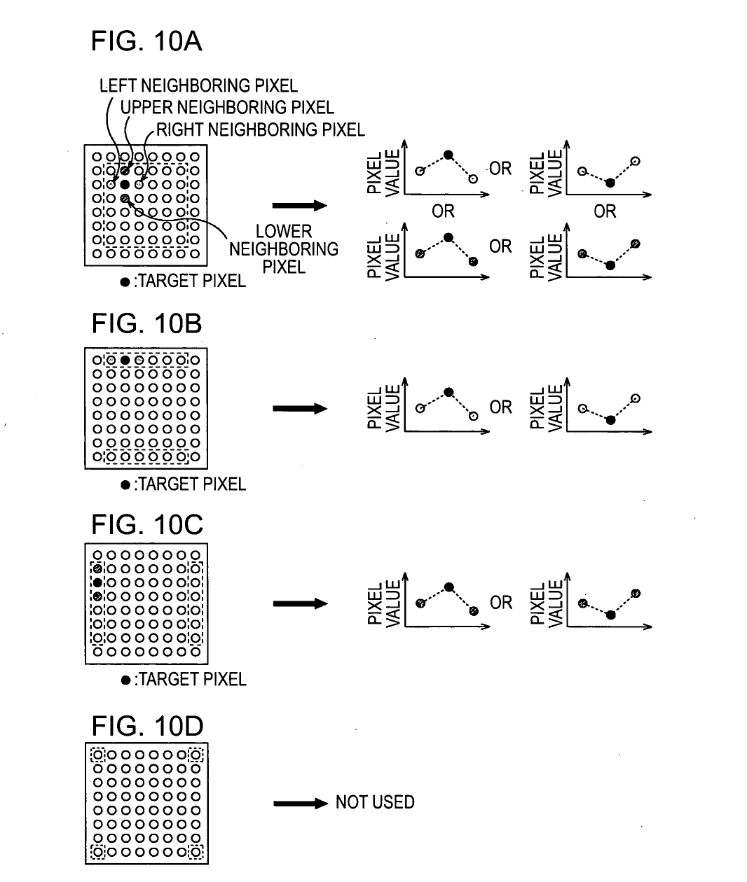

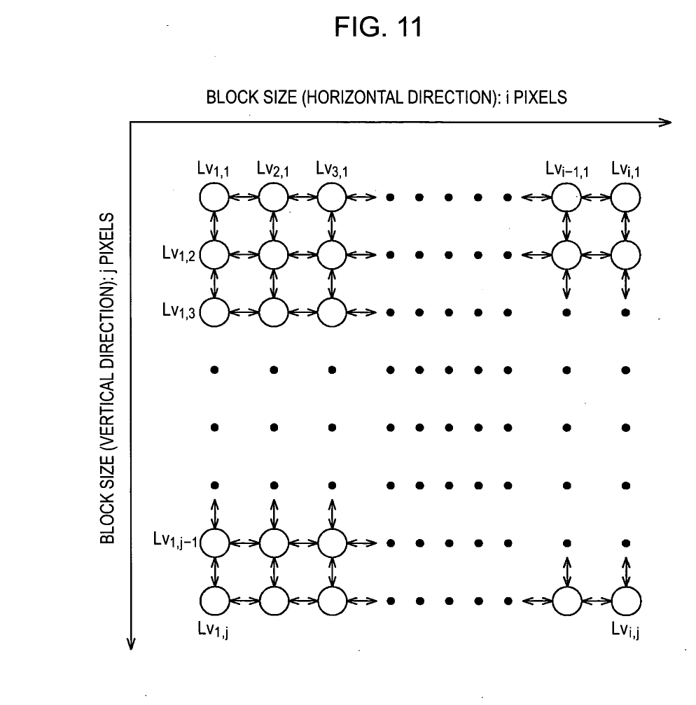

A number of extreme values calculation part 81 of the characteristic amount detection unit 62 calculates the number of pixels whose pixel values are the maximum or the minimum (the number of extreme values) from among pixels included in each block. A method for calculating the number of extreme values will be described later with reference to FIGS. 10A to 10D. An activity calculation part 82 calculates an activity, which is an average of the total sum of differences between pixel values of pixels included in each block and pixel values of pixels located at the top, bottom, left, and right sides of the respective pixels and which is a value representing a variation of the pixel values of the pixels included in the block. A larger activity is acquired as the variation of pixel values in a block increases. In contrast, a smaller activity is acquired as the variation of pixel values in a block decreases. A method for calculating an activity will be described later with reference to FIG. 11. A dynamic range calculation part 83 detects the maximum value and the minimum value of pixel values of pixels included in each block, and calculates the difference between the maximum value and the minimum value as a dynamic range.

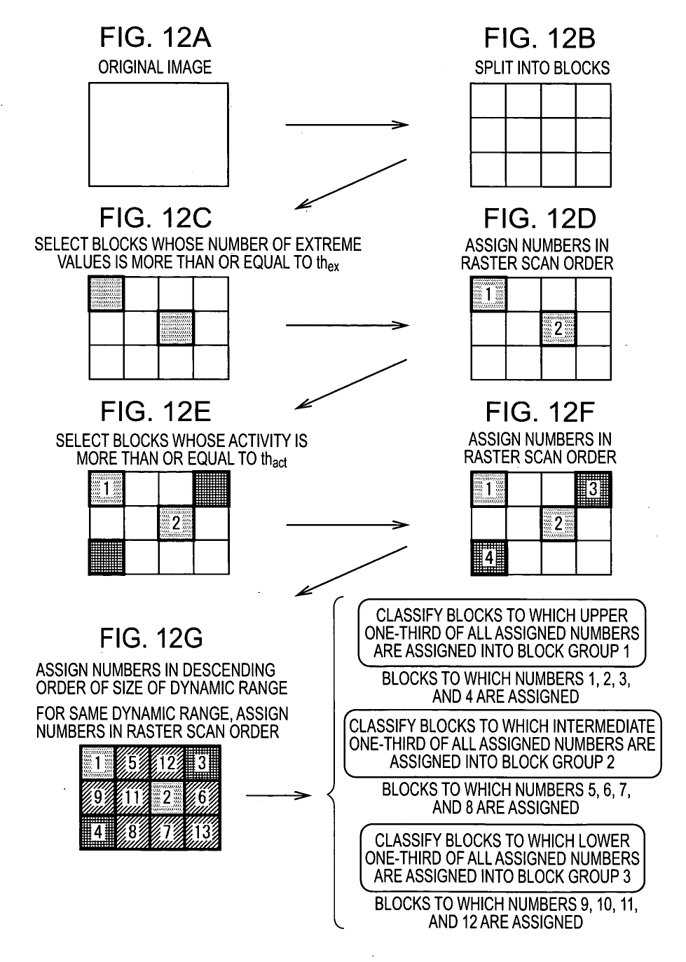

A block number assigning part 84 of the encoding method determination unit 63 assigns, in accordance with the calculated number of extreme values, activity, and dynamic range, a serial number to each block obtained by splitting an image. A method for assigning a serial number will be described later with reference to FIGS. 12A to 12G. A block group determination part 85 classifies a plurality of blocks, which is obtained by splitting the image, into three block groups, a block group constituted by blocks to which the upper one-third of assigned serial numbers are assigned (hereinafter, referred to as a block group 1), a block group constituted by blocks to which the intermediate one-third of the assigned serial numbers are assigned (hereinafter, referred to as a block group 2), and a block group constituted by the lower one-third of the assigned serial numbers are assigned (hereinafter, referred to as a block group 3).

A quantization part 86 of the block-encoding unit 64 performs DCT, adopting a Quality corresponding to a classified block group, on each block obtained by splitting the image. The quantization part 86 outputs a DCT coefficient corresponding to each block, which is obtained as a result of DCT, and the applied Quality to the subsequent stage as encoded image data V_{cd}.

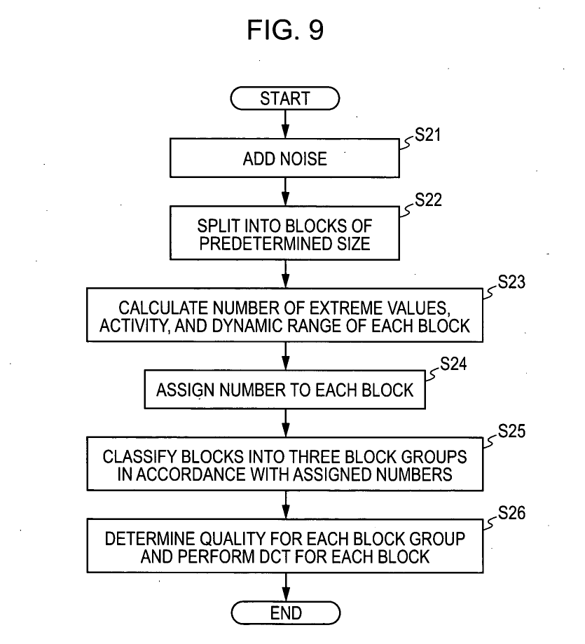

The operation of the encoding section 22 of the second configuration example will be described with reference to the flowchart shown in FIG. 9 by way of example of the encoding section 22-2 of the encoding apparatus 16.

In step S21, the noise-adding unit 42 of the A/D converter section 41 adds noise to an analog image signal Vₐₙ₁ before digitization. However, the processing in step S21 may be omitted.

In step S22, the block split unit 61 splits an input image into blocks of a predetermined size (for example, 8×8 pixels).

In step S23, the number of extreme values calculation part 81 calculates the number of pixels having prominent pixel values compared with peripheral pixels (that is, the number of extreme values) from among pixels included in each block. A method for calculating the number of extreme values will be described with reference to FIG. 10A to 10D.

Pixels included in a block are sequentially focused on, and it is determined whether or not a pixel value is an extreme value (a maximum value or a minimum value). The number of pixels whose pixel values are extreme values is counted. Accordingly, the number of extreme values is calculated.

The method for determining whether or not the pixel value of a pixel is an extreme value is different depending on the position of the pixel. Hereinafter, a pixel for which it is determined whether or not the pixel value is an extreme value is referred to as a target pixel, and the pixel value of the target pixel is represented by “L”. Pixel values of pixels located at the top, bottom, left, and right sides of the target pixel are represented by Lᵤ, L_{d}, Lₗ, and Lᵣ, respectively.

For pixels other than outermost pixels of a block (for example, for 7×7 pixels when the block is constituted by 8×8 pixels), as shown in FIG. 10A, if one of the four conditions given below is satisfied, it is determined that the pixel value is an extreme value.

Condition 1: (L_{c}>Lₗ) and (L_{c}>Lᵣ)

Condition 2: (L_{c}<Lₗ) and (L_{c}<Lᵣ)

Condition 3: (L_{c}>Lᵤ) and (L_{c}>L_{d})

Condition 4: (L_{c}<Lᵤ) and (L_{c}<L_{d})

For pixels located at the top and bottom sides other than pixels located at the vertices of the block, as shown in FIG. 10B, if one of the two conditions given below is satisfied, it is determined that the pixel value is an extreme value.

Condition 1: (L_{c}>Lₗ) and (L_{c}>Lᵣ)

Condition 2: (L_{c}<Lₗ) and (L_{c}<Lᵣ)

For pixels located at the left and right sides other than pixels located at the vertices of the block, as shown in FIG. 10C, if one of the two conditions given below is satisfied, it is determined that the pixel value is an extreme value.
Condition 1: (L_{c}>Lᵤ) and (L_{c}>L_{d})
Condition 2: (L_{c}<Lᵤ) and (L_{c}<L_{d})

For four pixels located at the vertices of the block, as shown in FIG. 10D, it is determined that the pixel value is not an extreme value, irrespective of any pixel value.

Then, the activity calculation part 82 calculates an activity of each block. A method for calculating an activity will be described with reference to FIG. 11. FIG. 11 shows an example when a block whose activity is to be calculated has i×j pixels (i pixels in the horizontal direction and j pixels in the vertical direction). A pixel value of an upper-left pixel of the block is represented by “Lv_{1,1}” and a pixel value of a pixel located at the right of that pixel is represented by “Lv_{2,1}”. Pixel values of other pixels are represented similarly. An activity Act of the i×j pixel block is calculated using the following condition:

$$Act = \frac{{\sum }_{n = 1}^{ i - 1} {\sum }_{m = 1}^{ j} \vert {Lv}_{ n + 1 , m} - {Lv}_{ n , m} \vert + {\sum }_{n = 1}^{ i} {\sum }_{m = 1}^{ j} \vert {Lv}_{ n , m + 1} - {Lv}_{ n , m} \vert}{( i - 1 ) \times j + i \times ( j - 1 )} \qquad ( 1 )$$

As is clear from Condition (1), an activity represents an average of the total sum of differences between pixel values of pixels included in a block and pixel values of pixels located at the top, bottom, left, and right sides of the respective pixels, in other words, the activity is a value representing a variation of the pixel values of the pixels included in the block. If a variation increases, an activity also increases. In contrast, if a variation decreases, an activity also decreases.

Although differences between a pixel value of a target pixel and pixel values of pixels located at the top, down, left, and right sides of the target pixel are calculated in condition (1), differences of the pixel value of the target pixel and pixel values of pixels located in the oblique direction may also be calculated. In addition, calculation of the activity is not necessarily performed using condition (1). The activity may be calculated based on other conditions as long as the activity represents a variation of pixel values of pixels belonging to a block.

Then, the dynamic range calculation part 83 calculates a dynamic range of each block. More specifically, the maximum value max and the minimum value min of pixel values of pixels included in the block are detected, and the difference between the maximum value max and the minimum value min is calculated as a dynamic range dr(=max-min).

The operations of the number of extreme values calculation part 81, the activity calculation part 82, and the dynamic range calculation part 83 are not necessarily performed in the order described above. The operations of the number of extreme values calculation part 81, the activity calculation part 82, and the dynamic range calculation part 83 may be performed at the same time.

Referring back to FIG. 9, in step S24, the block number assigning part 84 assigns serial numbers to blocks obtained by splitting the image. A method for assigning numbers will be described with reference to FIGS. 12A to 12G.

As shown in FIG. 12C, blocks whose number of extreme values is more than or equal to a predetermined threshold thₑₓ are extracted. Then, as shown in FIG. 12D, serial numbers are assigned to the extracted blocks in a raster scan order. Then, as shown in FIG. 12E, blocks whose activity is more than or equal to a predetermined threshold th_{act} are extracted from among blocks to which numbers are not assigned. Then, as shown in FIG. 12F, subsequent serial numbers are assigned to the extracted blocks in the raster scan order. Then, as shown in FIG. 12G, subsequent serial numbers are assigned to blocks to which numbers are not assigned in descending order of the size of the dynamic range. If a plurality of blocks has the same dynamic range, numbers are assigned in the raster scan order. The thresholds thₑₓ and th_{act} can be set in a desired manner. As described above, after serial numbers are assigned to all the blocks constituting the image, the process proceeds to step S25.

In step S25, the block-group determination part 85 classifies the plurality of blocks, which is obtained by splitting the image, into three block groups, a block group 1 constituted by blocks to which the upper one-third of all the assigned serial numbers are assigned, a block group 2 constituted by blocks to which the intermediate one-third of all the assigned serial numbers are assigned, and a block group 3 constituted by blocks to which the lower one-third of all the assigned serial numbers are assigned.

In step S26, the quantization part 86 performs DCT using a Quality of 90 for the blocks classified into the block group 1, using a Quality of 75 for the blocks classified into the block group 2, and using a Quality of 20 for the blocks classified into the block group 3.

The Quality, which is a parameter for determining an image quality, ranges between 0 and 100. Quantization with the highest image quality is achieved (that is, the deterioration is minimized) when the Quality is 100. In DCT processing, the Quality is used when a quantization table Q is scaled. A quantization table Q′ after scaling is calculated based on one of the following conditions:
Q′=Q×(50/Quality) (Quality<50) (2),
Q′=Q×(100−Quality/50) (50<Quality) (3)

Then, a DCT coefficient, which is a DCT result of each block, and a Quality applied to each block are output as encoded image data V_{cd} to the subsequent stage. Then, the encoded digital image data V_{cd} is recorded on the recording medium 17 by the recording section 44 or decoded by the decoding section 31-2. As described above, the encoding section 22 of the second configuration example operates.

The second configuration example of the decoding section 31 that performs decoding processing corresponding to encoding processing performed by the encoding section 22 of the second configuration example is described next. FIG. 13 shows the second configuration example of the decoding section 31. In the second configuration example of the decoding section 31, compared with the first configuration example shown in FIG. 6, the encoded data separation unit 71 and the block-decoding unit 72 are described in more details.

A quality detection part 91 of the encoded data separation unit 71 detects a Quality of each block from encoded digital image data V_{cd} input from the previous stage, and outputs the detected Quality and a remaining DCT coefficient to the block-decoding unit 72.

A dequantization part 92 of the block-decoding unit 72 scales a quantization table using the Quality input from the encoded data separation unit 71 for each block to be decoded. Then, the dequantization part 92 performs inverse DCT based on the DCT coefficient and decodes pixel values of pixels.

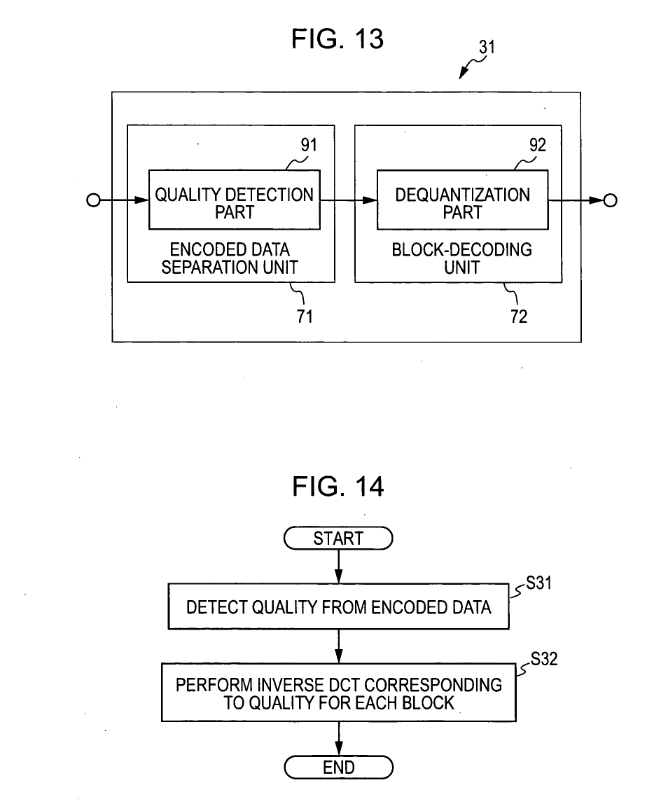

The operation of the decoding section 31 of the second configuration example will be described with reference to the flowchart shown in FIG. 14 by way of example of the decoding section 31-2 of the encoding apparatus 16. Encoded digital image data V_{cd} output from the encoding section 22-2 (or encoded digital image data V_{rd} read from the recording medium 17 by the recording section 44) is supplied to the decoding section 31-2.

In step S31, the quality detection part 91 of the encoded data separation unit 71 detects a Quality of each block from encoded digital image data V_{cd} input from the previous stage, and outputs the detected Quality and a remaining DCT coefficient to the block-decoding unit 72. In step S32, after scaling a quantization table using the Quality input from the encoded data separation unit 71 for each block to be decoded, the dequantization part 92 of the block-decoding unit 72 performs inverse DCT using the DCT coefficient. The dequantization part 92 outputs a digital image signal V_{dg2}, which is a decoding result, to the subsequent stage.

The digital image signal V_{dg2} is the above-described “image after second encoding and decoding processing”, and has lower image quality. Thus, copying of an analog image signal Vₐₙ₁ using the encoding apparatus 16 can be inhibited.

The image quality of the digital image signal V_{dg2} (that is, the image after second encoding and decoding processing) output from the decoding section 31-2 of the second configuration example is lower than the digital image signal V_{dg1} (that is, the image after first encoding and decoding processing) output from the decoding section 31-1 of the second configuration example. The fact that the image quality of the digital image signal V_{dg2} is lower than the image quality of the digital image signal V_{dg1} is described next.

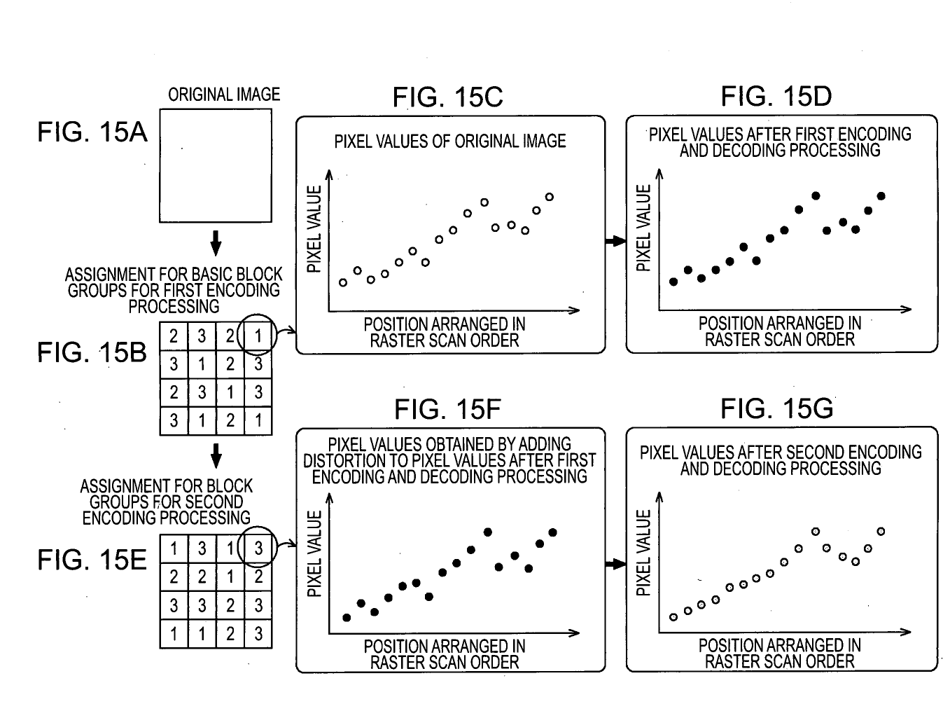

FIGS. 15A to 15G show the outline of the degradation in the image quality due to the second encoding and decoding processing. When an original image is as shown in FIG. 15A, blocks are classified into the block groups 1 to 3, as shown in FIG. 15B, for the first encoding processing. Here, an encircled block located in the upper right portion of the image (hereinafter, referred to as a target block) is taken as an example. Pixel values of pixels included in the target block are as shown in FIG. 15C. Since the target block is classified into the block group 1 in the first encoding processing, DCT is performed with a Quality of 90, that is, with the highest image quality. Thus, after the first encoding and decoding processing, the “pixel values after first encoding and decoding processing” shown in FIG. 15D are acquired, and values close to the original signal can be ensured.

However, even if a target block is classified into the block group 1 for the first encoding processing, the target block is not necessarily classified into the block group 1 for the second encoding processing due to addition of white noise. For example, addition of white noise may change the numbers of extreme values, activities, dynamic ranges of the target block and other blocks. Thus, the target block may be classified into the block group 3 (see FIG. 15E).

In the second encoding processing, pixel values of pixels included in the target block are changed to “pixel values obtained by adding distortion to pixel values after first encoding and decoding processing”. In addition, since the target block is classified into the block group 3, DCT is performed with a Quality of 20, that is, with the lowest image quality. In this case, after second encoding and decoding processing, high-frequency components of the image are largely cut, and “pixel values after the second encoding and decoding processing”—shown in FIG. 15G are acquired.

As is clear from comparison between the “pixel values after second encoding and decoding processing” shown in FIG. 15G and the “pixel values of the original image” shown in FIG. 15C, the pixel values after the second encoding and decoding processing and the pixel values of the original image are greatly different from each other. As described above, in the first encoding processing, since a target block is appropriately classified into a block group in accordance with the number of extreme values, an activity, and a dynamic range based on an original signal of each block, degradation in the image quality is suppressed. However, in the second encoding processing, since the number of extreme values, an activity, and a dynamic range change due to white noise and the target block is not appropriately classified into a block group, the image quality is degraded. Obviously, the image quality of the “pixel values after second encoding and decoding processing” is lower than the image quality of the “pixel values after first encoding and decoding processing” shown in FIG. 15D.

The third configuration example of the encoding section 22 is described next with reference to FIG. 16. In the third configuration example of the encoding section 22, compared with the first configuration example shown in FIG. 4, the characteristic amount detection unit 62, the encoding method determination unit 63, and the block-encoding unit 64 are described in more details.

The block split unit 61 splits an input image into blocks of a predetermined size (for example, 8×8 pixels).

A number of extreme values calculation part 101 of the characteristic amount detection unit 62 calculates the number of pixels having prominent pixel values compared with peripheral pixels (that is, the number of extreme values) from among pixels included in each block, similarly to the number of extreme values calculation part 81 in the second configuration example described above.

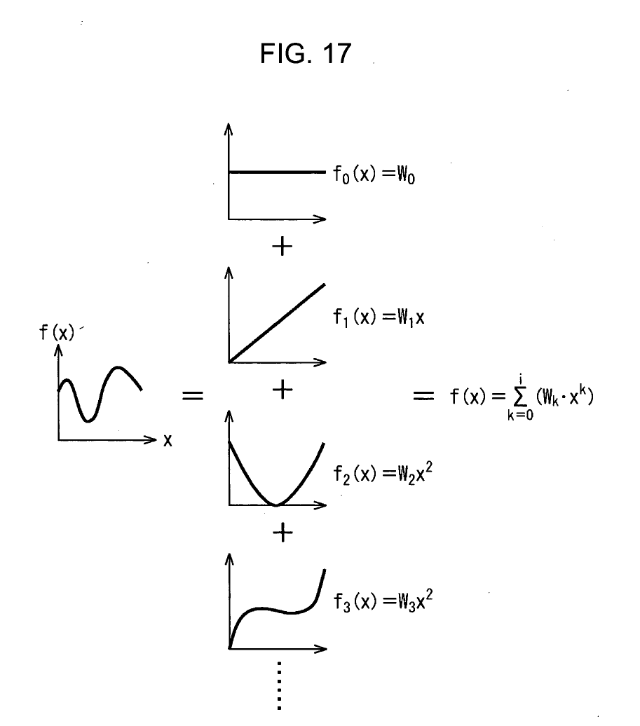

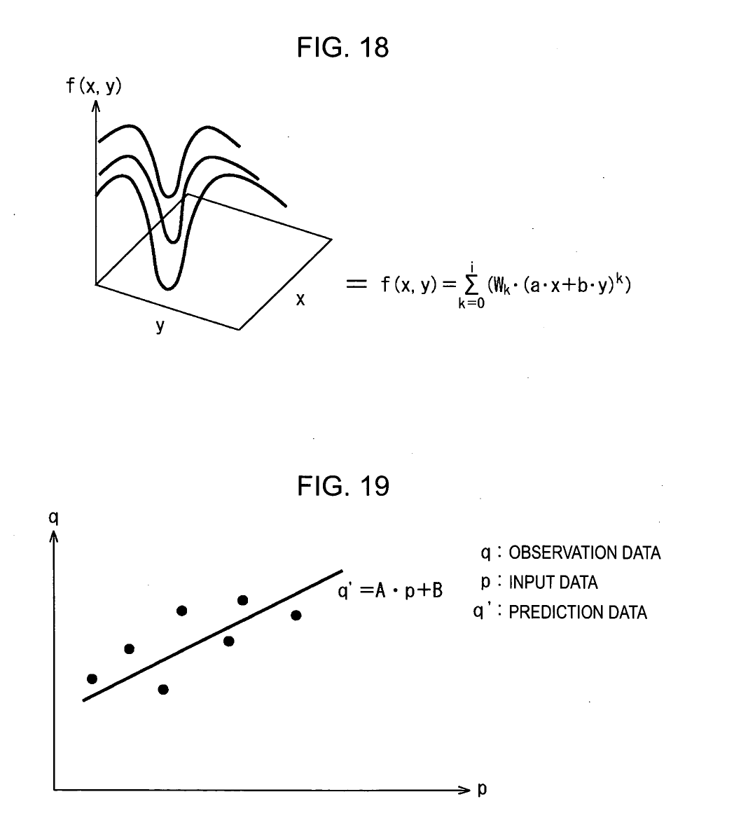

A two-dimensional ith-degree polynomial determination part 102 of the encoding method determination unit 63 determines a degree i of a two-dimensional ith-degree polynomial by comparing the calculated number of extreme values and a predetermined threshold for each block. The two-dimensional ith-degree polynomial represents pixel values of pixels included in a group as a function f(x,y) of positions (x,y) of the pixels. A coefficient wₖ of each degree term of the two-dimensional ith-degree polynomial f(x,y) is determined by a quantization part 103 in the subsequent stage. The two-dimensional ith-degree polynomial f(x,y) will be described below with reference to FIGS. 17 and 18.

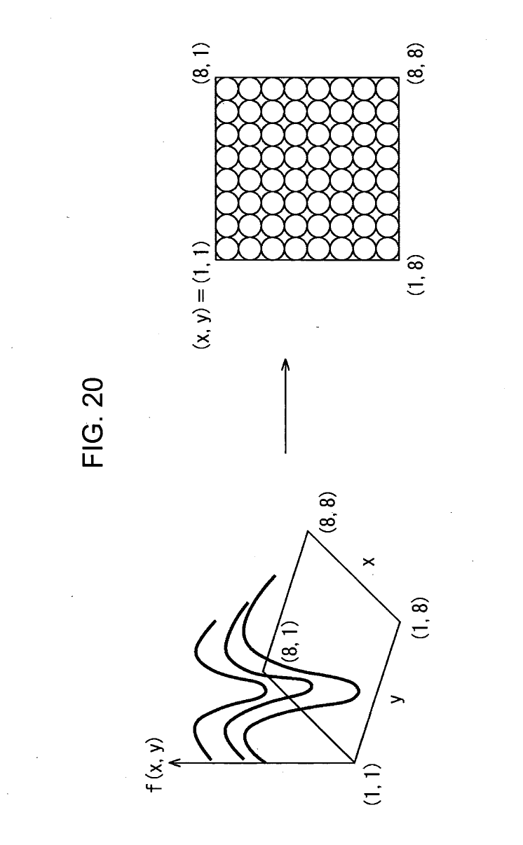

For each block, the quantization part 103 of the block-encoding unit 64 calculates, based on a least squares method using positions (x,y) of pixels included in the block as input data and using pixel values f(x,y) as observation data, a coefficient wₖ of each degree term of the two-dimensional ith-degree polynomial f(x,y) whose degree i is determined. The least squares method will be described with reference to FIGS. 19 and 20. As an encoding result for each block, the degree i of the two-dimensional ith-degree polynomial f(x,y) and the coefficient wₖ of each degree term are output as encoded image data V_{cd} to the subsequent stage.

The two-dimensional ith-degree polynomial f(x,y) is described next.

FIG. 17 shows an example of a one-dimensional ith-degree polynomial f(x), which is a function of a variable x. The one-dimensional ith-degree polynomial f(x) is represented as the total sum of a 0th-degree function f₀(x), a 1st-degree function f₁(x), a 2nd-degree function f₂(x), a 3rd-degree function f₃(x), . . . , and ith-degree function fᵢ(x), as represented by the following condition:
f(x)=Σ(Wₖ·x^{k}) (4),
where Σ represents the total sum of k=0, . . . , and i, and Wₖ represents a coefficient.

The two-dimensional ith-degree polynomial f(x,y) is obtained by two-dimensionally expanding the one-dimensional ith-degree polynomial f(x). The two-dimensional ith-degree polynomial f(x,y) is represented by the following condition:
f(x,y)=Σ(Wₖ·(a·x+b·y)^{k}) (5),
where Σ represents the total sum of k=0, . . . , and i, and Wₖ, a, and b represent coefficients.

An example of the two-dimensional ith-degree polynomial f(x,y), which is a function of a variable (x,y), is shown in FIG. 18.

For example, for a two-dimensional ith-degree polynomial f(x,y) when the degree i is 0, the following condition is satisfied:
f(x,y)=w₀ (6),
and a two-dimensional waveform can be represented using a coefficient w₀.

For example, for a two-dimensional ith-degree polynomial f(x,y) when the degree i is 1, the following condition is satisfied:
f(x,y)=w₂·x+w₁·y+w₀ (7),
and a two-dimensional waveform can be represented using three coefficients w₀, w₁, and w₂.

For example, for a two-dimensional ith-degree polynomial f(x,y) when the degree i is 2, the following condition is satisfied:
f(x,y)=w₅·x²+w₄·xy+w₃·y²+w₂x+w₁·y+w₀ (8),
and a two-dimensional waveform can be represented using six coefficients, w₀, . . . , and w₅.

For example, for a two-dimensional ith-degree polynomial f(x,y) when the degree i is 3, the following condition is satisfied:
f(x,y)=w₉·x³+w₈·y³+w₇·x²y+w₆·xy²+w₅·x²+w₄·xy+w₃·y²+w₂·x+w₁·y+w₀ (9),
and a two-dimensional waveform can be represented using ten coefficients, w₀, . . . , and w₉.

A method for calculating a coefficient wₖ using the least squares method is described next.

FIG. 19 shows the concept of the least squares method. In the least squares method, input data p (in this case, positions (x,y) of pixels included in a block) and observation data q (in this case, pixel values of the pixels included in the block) are input, and coefficients of prediction data q′ is determined such that points represented by the input data p and the observation data q most fit the line represented by the prediction data q′, which is a function of the input data p.

In the example shown in FIG. 19, seven samples, that is, the observation data q, is input, and the prediction data q′ is represented by the following linear predictive condition:
q′=A·p+B (10).

When the error between the input observation data q and the prediction data q′ is represented by the condition e=q−q′, the square error sum E of the errors e is represented by the following condition:
E=Σ(q−A·p+B)² (11),
where Σ represents the total sum of the samples.

The coefficients A and B are calculated such that the square error sum E is the minimum. More specifically, the coefficients A and B are calculated such that values obtained by partially differentiating the square error sum E with respect to the coefficients A and B are 0, as represented by the following condition:
∂E/∂A=0, ∂E/∂B=0 (12).

If an image is split into blocks each including 8×8 pixels, as shown in FIG. 20, the quantization part 103 calculates a coefficient wₖ such that the square error sum E between the observation data q and the prediction data q′ is the minimum by using positions (x,y) of 64 (=8×8) pixels as input data p, using pixel values of the pixels as observation data q, and using the prediction data q′ as a two-dimensional ith-degree polynomial f(x,y), which is represented by Σ(Wₖ·a·x+b·y)^{k}).

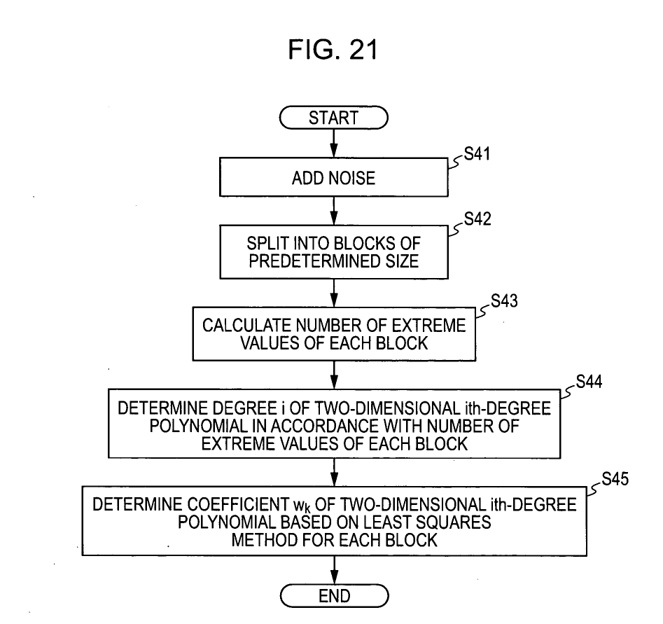

The operation of the encoding section 22 of the third configuration example will be described with reference to the flowchart shown in FIG. 21 by way of example of the encoding section 22-2 of the encoding apparatus 16.

In step S41, the noise-adding unit 42 of the A/D converter section 41 adds noise to an analog image signal Vₐₙ₁ before digitization. However, the processing in step S41 may be omitted.

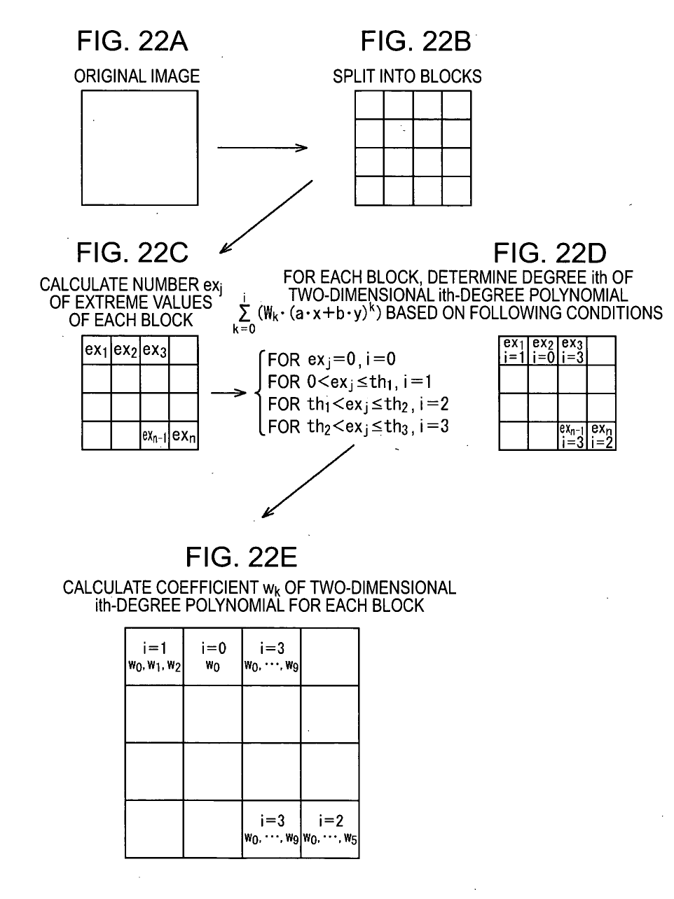

In step S42, the block split unit 61 splits an input image (for example, an original image shown in FIG. 22A) into blocks of a predetermined size (for example, 8×8 pixels), as shown in FIG. 22B.

In step S43, the number of extreme values calculation part 101 calculates the number ex of extreme values of each block (for example, the number of extreme values of a block j is referred to as exⱼ), as shown in FIG. 22C. The method for calculating the number ex of extreme values is similar to the method described above with reference to FIGS. 10A to 10D, the description of the method is omitted here.

In step S44, the two-dimensional ith-degree polynomial determination part 102 determines a degree i of a two-dimensional ith-degree polynomial by comparing the calculated number exⱼ of extreme values and predetermined threshold th₁, th₂, and th₃ for each block. More specifically, as shown in FIG. 22D, the degree i is set to 0, 1, 2, or 3 in accordance with the following conditions:

for exⱼ=0, i=0,

for 0<exⱼ≦th₁, i=1,

for th₁<exⱼ≦th₂, i=2, and

for th₂<exⱼ≦th₃, i =3.

Here, the thresholds th₁, th₂, and th₃ can be set in a desired manner as long as the condition th₁<th₂<th₃ is satisfied. In addition, the number of the thresholds th may be four or more. Furthermore, fourth degree or more may be set as the degree i. However, the upper limit of the number of thresholds th and the upper limit of the degree i are within the range in which a coefficient wₖ of each degree term of the two-dimensional ith-degree polynomial can be calculated by the least squares method in the subsequent stage.

In step S45, for each block j, the quantization part 103 calculates, based on the least squares method using positions and pixel values of pixels included in the block j as input, the coefficient wₖ of the two dimensional ith-degree polynomial whose degree i is determined. Then, the quantization part 103 outputs to the subsequent stage the degree i and the coefficient wₖ of the two-dimensional ith-degree polynomial for each block as encoded image data V_{cd}. Then, the encoded digital image data V_{cd} is recorded on the recording medium 17 by the recording section 44 or decoded by the decoding section 31-2. As described above, the encoding section 22 of the third configuration example operates.

The decoding section 31 of the third configuration example that performs decoding processing corresponding to encoding processing performed by the encoding section 22 of the third configuration example is described next. FIG. 23 shows the third configuration example of the decoding section 31. In the third configuration example of the decoding section 31, compared with the first configuration example shown in FIG. 6, the encoded data separation unit 71 and the block-decoding unit 72 are described in more details.

An i·wₖ detection part 111 of the encoded data separation unit 71 detects a degree i and a coefficient wₖ of a two-dimensional ith-degree polynomial for each block from encoded digital image data V_{cd} input from the previous stage, and outputs the detected degree i and coefficient wₖ to the block-decoding unit 72.

A two-dimensional ith-degree polynomial reconstruction part 112 of the block-decoding unit 72 reconstructs the two-dimensional ith-degree polynomial f(x,y) for the corresponding block in accordance with the degree i and the coefficient wₖ of the corresponding two-dimensional ith-degree polynomial input from the encoded data separation unit 71. A pixel value calculation part 113 calculates pixel values of pixels by substituting positions (x,y) of the pixels included in the corresponding block into the two-dimensional ith-degree polynomial f(x,y) reconstructed for the block.

The operation of the decoding section 31 of the third configuration example will be described with reference to the flowchart shown in FIG. 24 by way of example of the decoding section 31-2 of the encoding apparatus 16. Encoded digital image data V_{cd} output from the encoding section 22-2 (or encoded digital image data V_{rd} read from the recording medium 17 by the recording section 44) is supplied to the decoding section 31-2.

In step S51, the i·wₖ detection part 111 of the encoded data separation unit 71 detects a degree i and a coefficient wₖ of a two-dimensional ith-degree polynomial for each block from the encoded digital image data V_{cd} input from the previous stage, and outputs the detected degree i and coefficient wₖ to the block-decoding unit 72. In step S52, the two-dimensional ith-degree polynomial reconstruction part 112 reconstructs the two-dimensional ith-degree polynomial f(x,y) for the corresponding block in accordance with the degree i and the coefficient wₖ of the corresponding two-dimensional ith-degree polynomial input from the encoded data separation unit 71.

In step S53, the pixel value calculation part 113 calculates pixel values of pixels by substituting positions (x,y) of the pixels included in the corresponding block into the two-dimensional ith-degree polynomial f(x,y) reconstructed for the block. Then, the pixel value calculation part 113 outputs the pixel values calculated as described above to the subsequent stage as a digital image signal V_{dg2}, which is a decoding result.

The digital image signal V_{dg2} is the above-described “image after second encoding and decoding processing”, and has lower image quality. Thus, copying of an analog image signal Vₐₙ₁ using the encoding apparatus 16 can be inhibited.

The image quality of the digital image signal V_{dg2} output from the decoding section 31-2 of the third configuration example (that is, the image after second encoding and decoding processing) is lower than the image quality of the digital image signal V_{dg1} output from the decoding section 31-1 of the third configuration example (that is, the image after first encoding and decoding processing). The fact that the image quality of the digital image signal V_{dg2} is lower than the image quality of the digital image signal V_{dg1} will be described.

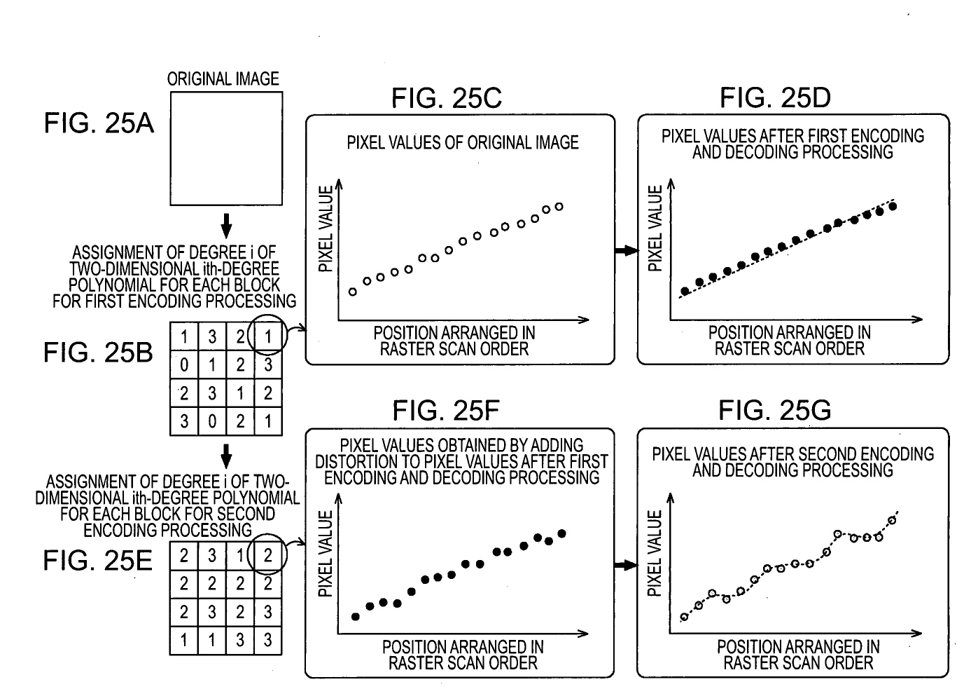

FIGS. 25A to 25G show the outline of the degradation in the image quality due to the second encoding and decoding processing. When an original image is as shown in FIG. 25A, the degree i of a two-dimensional ith-degree polynomial for each block is determined, as shown in FIG. 25B, for the first encoding processing. Here, an encircled block located in the upper right portion of the image (hereinafter, referred to as a target block) is taken as an example. Pixel values of pixels included in the target block are as shown in FIG. 25C. Since, in the first encoding processing, the target block has a relatively small number of extreme values, the degree i is set to 1. Thus, the pixel values of the pixels included in the target block are represented by a two-dimensional polynomial of degree 1 of pixel positions (x,y). After the first encoding and decoding processing, the “pixel values after the first encoding and decoding processing” shown in FIG. 25D, which fit the two-dimensional polynomial of degree 1, are acquired, and values close to the original signal can be ensured.

However, even if the degree i of a target block is set to 1 for the first encoding processing, the degree i is not necessarily set to 1 for the second encoding processing due to addition of white noise. For example, the pixel values of pixels of the target block may be changed to “pixel values obtained by adding distortion to pixel values after first encoding and decoding processing” shown in FIG. 25F due to addition of white noise in the second encoding processing. The number of extreme values may increase, and thus the degree i of the target block may be set to 2 (see FIG. 25E).

In this case, in the second decoding processing, pixel values in the target block are represented by a two-dimensional polynomial of degree 2 of pixel positions (x,y). Thus, after the second encoding and decoding processing, “pixel values after second encoding and decoding processing” shown in FIG. 25G, which fit the two-dimensional polynomial of degree 2, are acquired.

As is clear from comparison between the “pixel values after second encoding and decoding processing” shown in FIG. 25G and the “pixel values of the original image” shown in FIG. 25C, the pixel values after the second encoding and decoding processing and the pixel values of the original image are greatly different from each other. As described above, in the first encoding processing, since the degree i of a two dimensional ith-degree polynomial is determined in accordance with the number of extreme values based on an original signal of each block, degradation in the image quality is suppressed. However, in the second encoding processing, since the number of extreme values changes due to white noise and the degree i is not appropriately set, the image quality is degraded. Obviously, the image quality of the “pixel values after second encoding and decoding processing” is lower than the image quality of the “pixel values after first encoding and decoding processing” shown in FIG. 25D.

As described above, due to characteristics in digital-to-analog conversion, analog noise (that is, distortion including high-frequency components added thereto) is generated in an analog image signal Vₐₙ₁ output from the playback apparatus 14. However, such analog noise does not affect the image quality for display on the display 15.

However, if the analog image signal Vₐₙ₁ output from the playback apparatus 14 is re-encoded by the encoding apparatus 16, the encoding processing is performed such that the image quality is degraded when decoding. Thus, the encoding apparatus 16 is not suitable for copying of an analog image signal.

In addition, if the recording medium 17 on which encoded digital image data V_{cd} is recorded by the encoding apparatus 16 is played back by the playback apparatus 14 or the like and the playback result is re-encoded by the encoding apparatus 16 while a user knows deterioration of the playback result, the image quality is further degraded when decoding. Thus, the encoding apparatus 16 is not suitable for the second and subsequent copying processing for an analog image signal. Therefore, copying of analog data using the encoding apparatus 16 is inhibited.

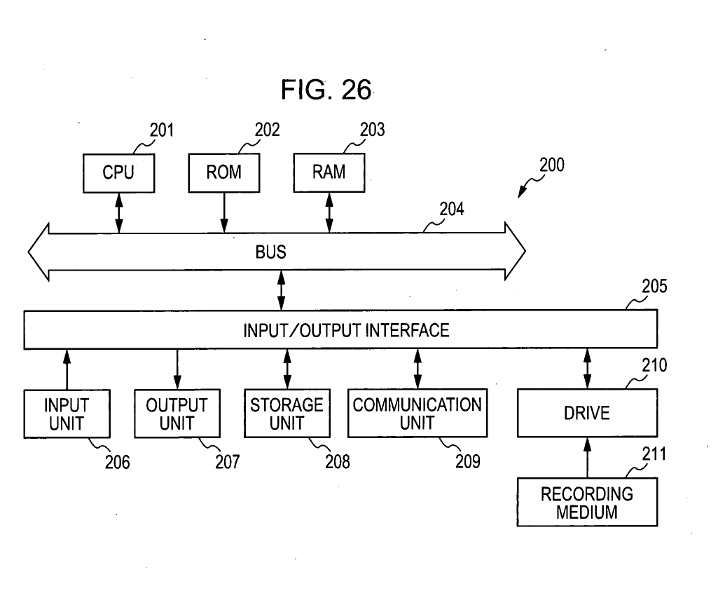

The foregoing series of processing may be performed by hardware or software. If the foregoing series of processing is performed by software, a program constituting the software is installed from a recording medium on a computer installed in dedicated hardware or a general-purpose personal computer, for example, shown in FIG. 26, capable of performing various functions by installing various programs.

A personal computer 200 includes a central processing unit (CPU) 201. An input/output interface 205 is connected to the CPU 201 via a bus 204. A read-only memory (ROM) 202 and a random-access memory (RAM) 203 are connected to the bus 204.

An input unit 206 including an input device, such as a keyboard and a mouse, used by a user to input an operation command, an output unit 207 including a display that displays images and the like of processing results, a storage unit 208 including a hard disk drive that stores a program and various data, and a communication unit 209 that includes a modem, a local-area network (LAN) adaptor, and the like and that performs communication processing via a network, represented by the Internet, are connected to the input/output interface 205. In addition, a drive 210 that writes data to and from a recording medium 211, such as a magnetic disk (including a flexible disk), an optical disc (including a CD-ROM or a DVD), an optical magnetic disc (including an MD), or a semiconductor memory, is connected to the input/output interface 205.

The program for causing the personal computer 200 to perform the foregoing series of processing is stored on the recording medium 211 and supplied to the personal computer 200. The program is read by the drive 210 and installed into a hard disk drive contained in the storage unit 208. The program installed in the storage unit 208 is loaded from the storage unit 208 to the RAM 203 and executed in accordance with an instruction of the CPU 201 corresponding to a command input to the input unit 206 by the user.

In this specification, steps performed in accordance with a program are not necessarily performed in chronological order in accordance with the written order. The steps may be performed in parallel or independently without being performed in chronological order.

In addition, the program may be processed by a single computer or may be distributedly processed by a plurality of computers. Moreover, the program may be transferred to a remote computer and performed.

In addition, in this specification, the term “system” represents the entire equipment constituted by a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus for encoding input image data, comprising:
a splitting section that splits the image data into blocks of a predetermined size;
a detection section that detects, as a characteristic amount of each block split by the splitting section, at least the number of extreme values representing the number of pixels whose pixel values are extreme values;
a determination section that determines an encoding method for the block in accordance with the characteristic amount detected by the detection section; and
an encoding section that encodes the image data of the block in accordance with the encoding method for the block determined by the determination section.

2. The encoding apparatus according to claim 1, wherein noise is added to the image data.

3. The encoding apparatus according to claim 1, further comprising a noise-adding section that adds noise to the input image data.

4. The encoding apparatus according to claim 1, wherein after the image data is encoded at least once, the image data is decoded.

5. The encoding apparatus according to claim 1, further comprising a decoding section that decodes an output result of the encoding section.

6. The encoding apparatus according to claim 1, wherein the detection section detects, as the characteristic amount of the block split by the splitting section, an activity representing a variation of pixel values of pixels included in the block and a dynamic range of the pixels included in the block.

7. The encoding apparatus according to claim 6, wherein the determination section classifies the blocks into block groups in accordance with the characteristic amount detected by the detection section, and determines an identical encoding method for blocks belonging to an identical block group.

8. The encoding apparatus according to claim 6, wherein:
the determination section determines, as an encoding method, a quality functioning as a parameter for determining an image quality in discrete cosine transform; and
the encoding section performs the discrete cosine transform on the image data of the block using a quantization table adjusted in accordance with the quality determined by the determination section.

9. The encoding apparatus according to claim 8, wherein the encoding section outputs, as encoding results, a discrete cosine coefficient acquired by the discrete cosine transform and the quality for the block.

10. The encoding apparatus according to claim 1, wherein:
the determination section determines, as an encoding method, a degree of an approximate expression representing relationship between pixel values and pixel positions of pixels included in the block in accordance with the characteristic amount detected by the detection section; and
the encoding section calculates, in accordance with the pixel values and the pixel positions of the pixels included in the block, a coefficient of each degree term of the approximate expression whose degree is determined by the determination section.

11. The encoding apparatus according to claim 1, wherein:
the determination section determines, as an encoding method, a degree i of a two-dimensional ith-degree polynomial representing relationship between pixel values and pixel positions of pixels included in the block in accordance with the characteristic amount detected by the detection section; and
the encoding section calculates, using a least squares method based on the pixel values and the pixel positions of the pixels included in the block, a coefficient of each degree term of the two-dimensional ith-degree polynomial whose degree i is determined by the determination section.

12. The encoding apparatus according to claim 11, wherein the encoding section outputs, as encoding results, the degree i and the coefficient of the degree term of the two-dimensional ith-degree polynomial for the block.

13. An encoding method for encoding input image data, comprising the steps of:
splitting the image data into blocks of a predetermined size;
detecting, as a characteristic amount of each block split by the splitting step, at least the number of extreme values representing the number of pixels whose pixel values are extreme values;
determining an encoding method for the block in accordance with the characteristic amount detected by the detecting step; and
encoding the image data of the block in accordance with the encoding method for the block determined by the determining step.

14. A recording medium on which a computer-readable program for encoding input image data is recorded, the program comprising the steps of:
splitting the image data into blocks of a predetermined size;
detecting, as a characteristic amount of each block split by the splitting step, at least the number of extreme values representing the number of pixels whose pixel values are extreme values;
determining an encoding method for the block in accordance with the characteristic amount detected by the detecting step; and
encoding the image data of the block in accordance with the encoding method for the block determined by the determining step.

15. A decoding apparatus for decoding encoded data encoded by an encoding method determined in accordance with a characteristic amount of image data of each block acquired by splitting the image data into blocks of a predetermined size, the decoding apparatus comprising:
an extraction section that extracts from the encoded data information representing the encoding method for the block; and
a reconstruction section that determines a decoding method in accordance with the information extracted by the extraction section and that reconstructs the image data from the encoded data in accordance with the decoding method,
wherein the characteristic amount includes at least the number of extreme values representing the number of pixels whose pixel values are extreme values.

16. The decoding apparatus according, to claim 15, wherein:
the extraction section extracts, as the information representing the encoding method for the block, a discrete cosine coefficient acquired by discrete cosine transform and a quality from the encoded data; and
the reconstruction section reconstructs the image data by performing inverse discrete cosine transform on the discrete cosine coefficient using a quantization table adjusted in accordance with the quality.

17. The decoding apparatus according to claim 15, wherein:
the extraction section extracts, as the information representing the encoding method for the block, a degree and a coefficient of each degree term of an approximate expression representing relationship between pixel values and pixel positions of pixels included in the block from the encoded data; and
the reconstruction section reconstructs the image data by generating the approximate expression in accordance with the degree and the coefficient and by calculating the pixel values by substituting the pixel positions into the generated approximate expression.

18. A decoding method for decoding encoded data encoded by an encoding method determined in accordance with a characteristic amount of image data of each block acquired by splitting the image data into blocks of a predetermined size, the decoding method comprising the steps of:
extracting from the encoded data information representing the encoding method for the block; and
reconstructing the image data from the encoded data in accordance with a decoding method determined in accordance with the information extracted by the extracting step,
wherein the characteristic amount includes at least the number of extreme values representing the number of pixels whose pixel values are extreme values.

19. A recording medium on which a computer-readable program for decoding encoded data encoded by an encoding method determined in accordance with a characteristic amount of image data of each block acquired by splitting the image data into blocks of a predetermined size is recorded, the program comprising the steps of:
extracting from the encoded data information representing the encoding method for the block; and
reconstructing the image data from the encoded data in accordance with a decoding method determined in accordance with the information extracted by the extracting step,
wherein the characteristic amount includes at least the number of extreme values representing the number of pixels whose pixel values are extreme values.

20. An image processing system comprising:
an encoding section that encodes image data; and
a decoding section that decodes an output of the encoding section,
wherein the image data is deteriorated by repeating encoding processing and decoding processing on the image data,
wherein the encoding section includes a splitting unit that splits the image data into blocks of a predetermined size, a detection unit that detects, as a characteristic amount of each block split by the splitting unit, at least the number of extreme values representing the number of pixels whose pixel values are extreme values, a determination unit that determines an encoding method for the block in accordance with the characteristic amount detected by the detection unit, and an encoding unit that encodes the image data of the block in accordance with the encoding method for the block determined by the determination unit.

21. An image processing system comprising:
an encoding section that encodes image data; and
a decoding section that decodes an output of the encoding section,
wherein the image data is deteriorated by repeating encoding processing and decoding processing on the image data,
wherein the decoding section includes an extraction unit that extracts, from encoded data encoded by an encoding method determined in accordance with a characteristic amount of the image data of each block acquired by splitting the image data into blocks of a predetermined size, information representing the encoding method for the block, and a reconstruction unit that determines a decoding method in accordance with the information extracted by the extraction unit and that reconstructs the image data from the encoded data in accordance with the decoding method, and wherein the characteristic amount includes at least the number of extreme values representing the number of pixels whose pixel values are extreme values.

22. An encoding apparatus for encoding input image data, comprising:
splitting means for splitting the image data into blocks of a predetermined size;
detecting means for detecting, as a characteristic amount of each block split by the splitting means, at least the number of extreme values representing the number of pixels whose pixel values are extreme values;
determining means for determining an encoding method for the block in accordance with the characteristic amount detected by the detecting means; and
encoding means for encoding the image data of the block in accordance with the encoding method for the block determined by the determining means.

23. A decoding apparatus for decoding encoded data encoded by an encoding method determined in accordance with a characteristic amount of image data of each block acquired by splitting the image data into blocks of a predetermined size, comprising:
extracting means for extracting from the encoded data information representing the encoding method for the block; and
reconstructing means for determining a decoding method in accordance with the information extracted by the extracting means and for reconstructing the image data from the encoded data in accordance with the decoding method,
wherein the characteristic amount includes at least the number of extreme values representing the number of pixels whose pixel values are extreme values.
